(19) United States
(12) Patent Application Publication
(10) Pub. No.: US 2014/0112142 A1
(43) Pub. Date: Apr. 24, 2014

(54) METHOD OF FORWARDING PACKET AND APPARATUS THEREOF

(71) Applicant: ELECTRONICS AND TELECOMMUNICATIONS RESEARCH INSTITUTE, Daejeon (KR)

(72) Inventors: Nam Seok KO, Daejeon (KR); Sung Kee NOH, Daejeon (KR); Jong Dae PARK, Daejeon (KR); Soon Seok LEE, Daejeon (KR)

(73) Assignee: ELECTRONICS AND TELECOMMUNICATIONS RESEARCH INSTITUTE, Daejeon (KR)

(21) Appl. No.: 14/060,473

(22) Filed: Oct. 22, 2013

(30) Foreign Application Priority Data
Oct. 22, 2012 (KR) 10-2012-0117217
Oct. 21, 2013 (KR) 10-2013-0125078

(51) Int. Cl. H04L 12/801

(52) U.S. Cl. CPC H04L 47/33
USPC 370/235

(57) ABSTRACT

Provided are a method of packet forwarding and an apparatus therefor. In the method, a method performed in a network apparatus includes receiving at least one packet, providing the at least one packet to a network controller through a data plane when flow information to forward the at least one packet is not available and receiving a message including the flow information to forward the at least one packet from the network controller through a control plane. Therefore, the method and the apparatus may increase an efficiency of packet forwarding by simplifying procedure of configuring flow rules on newly input packets.

### CLAIM FOR PRIORITY

This application claims priority to Korean Patent Application No. 10-2012-0117217 filed on Oct. 22, 2012 and NO. 10-2013-0125078 filed on Oct. 21, 2013 in the Korean Intellectual Property Office (KIPO), the entire contents of which are hereby incorporated by reference.

### BACKGROUND

1. Technical Field

Example embodiments of the present invention relate in general to a method of packet forwarding method and an apparatus for the same, and more particularly, to a method and an apparatus for forwarding packets in network supporting software defined network (SDN).

2. Related Art

In a concept of conventional network, a function of control plane and a function of data plane are integrated and operate as one network apparatus. These network apparatuses are distributed in network environment and each control plane of apparatuses exchanges control protocol each other for packet forwarding. Thus, the complexity of network apparatuses increases.

On the other hand, manufacturers produce their network apparatuses by their own unique technologies and most of their confidential information on the network apparatuses not published. Thus, adding new function or enhancing existing function of the network apparatuses is not possible without any help of the manufacturers.

In order to solve these problems, a technology of the software defined networking (SDN) has been developed. The SDN technology is a networking technology which enables configuring network path and making complex network management easy by software programming The SDN technology separates the control plane and the data plane of network and provides standardized interface (for example, OpenFlow) between them. Most of intelligence exists in the control plane and the network apparatuses such as switch supporting SDN handle packets based on rules provided by unit of flow from the control plane through the standard interface.

In network supporting the above-mentioned SDN technologies, a network apparatus can request a flow rule provisioning to a network controller (that is, a controller supporting SDN) when the flow rule needed for handling input packets does not exist in flow table of it, and receive the flow rule from the network controller. The network apparatuses can forward the input packets based on the received flow rule. Since these procedures are performed iteratively in all the network apparatuses, there may be problem that an efficiency of packet forwarding decreases.

### SUMMARY

Accordingly, example embodiments of the present invention are provided to substantially obviate one or more problems due to limitations and disadvantages of the related art.

Example embodiments of the present invention provide a method of packet forwarding to increase an efficiency of packet forwarding by simplifying procedure of configuring flow rules on newly input packets.

Example embodiments of the present invention also provide a packet forwarding apparatus to increase an efficiency of packet forwarding by simplifying procedure of configuring flow rules on newly input packets.

In some example embodiments, an operation method of a network apparatus constituting a method of packet forwarding may include receiving at least one packet; providing the at least one packet to a network controller through a data plane when flow information to forward the at least one packet is not available; and receiving a message including the flow information to forward the at least one packet from the network controller through a control plane.

The method may further include forwarding the at least one packet based on the flow information.

The method may further include forwarding the at least one packet based on the flow information when the flow information is available.

Here, the at least one packet may be provided to the network controller based on OpenFlow protocol.

Here, the message including the flow information may be a message based on OpenFlow protocol.

Here, the network apparatus may be a switch supporting a software defined networking (SDN) technology.

Here, the network controller may be a controller supporting a software defined networking (SDN) technology.

Here, the flow information may include at least one of information on a flow rule, information on an action and information on a statistics.

In other example embodiments, an operation method of a network controller constituting a method of supporting packet forwarding may include receiving at least one packet from the network apparatus; generating flow information to forward the at least one packet; and transmitting the flow information to the network apparatus.

The method may further include transmitting the flow information to a network apparatus which the at least one packet will pass through.

Here, the at least one packet may be received from the network apparatus based on OpenFlow protocol.

Here, the flow information may be generated including at least one of information on a flow rule, information on an action and information on a statistics.

Here, the flow information may be transmitted to the network apparatus based on OpenFlow protocol.

Here, the network apparatus may be a switch supporting a software defined networking (SDN) technology.

Here, the network controller may be a controller supporting a software defined networking (SDN) technology.

In still other example embodiments, a network apparatus for packet forwarding may include a processor configured to receive at least one packet, provide the at least one packet to a network controller through a data plane when flow information for forwarding the at least one packet is not available, and receive a message including the flow information from the network controller through a control plane; and a storage configured to store information to be processed by the processor and information processed by the processor.

Here, the processor may be configured to forward the at least one packet based on the flow information received from the network controller.

Here, the processor may be configured to form a network with the network controller based on OpenFlow protocol.

Here, the network apparatus may be a switch supporting a software defined networking (SDN) technology.

Here, the flow information may include at least one of information on a flow rule, information on an action, and information on a statistics.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating an example structure of software defined networking (SDN);

FIG. 2 is a conceptual diagram illustrating an example embodiment for controlling packet path in network supporting SDN;

FIG. 3 is a conceptual diagram illustrating an example embodiment of a packet forwarding method;

FIG. 4 is a conceptual diagram illustrating a flow table;

FIG. 5 is a flow chart illustrating an example embodiment of packet forwarding m method according to the present invention;

FIG. 6 is a conceptual diagram illustrating an example embodiment of packet forwarding method according to the present invention;

FIG. 7 is a block diagram illustrating an example embodiment of a network apparatus according to the present invention; and

FIG. 8 is a block diagram illustrating an example embodiment of a network controller according to the present invention.

### DESCRIPTION OF EXAMPLE EMBODIMENTS

Example embodiments of the present invention are described below in sufficient detail to enable those of ordinary skill in the art to embody and practice the present invention. It is important to understand that the present invention may be embodied in many alternative forms and should not be construed as limited to the example embodiments set forth herein.

Accordingly, while the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims. Elements of the example embodiments are consistently denoted by the same reference numerals throughout the drawings and detailed description.

It will be understood that, although the terms first, second, A, B, etc. may be used herein in reference to elements of the invention, such elements should not be construed as limited by these terms. For example, a first element could be termed a second element, and a second element could be termed a first element, without departing from the scope of the present invention. Herein, the term “and/or” includes any and all combinations of one or more referents.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, numbers, steps, operations, elements, and/or components, but do not preclude the presence or addition of one or more other features, numbers, steps, operations, elements, components, and/or groups thereof.

Hereinafter, preferred embodiments of the present invention will be described in detail with reference to the accompanying drawings. In the drawings and description, elements that appear in more than one drawing and/or elements that are mentioned in more than one place in the description are always denoted by the same respective reference numerals and are not described in detail more than once.

Hereinafter, example embodiments of the present invention will be described in detail with reference to the appended drawings. To aid in understating the present invention, like numbers refer to like elements throughout the description of the figures, and the description of the same component will not be reiterated.

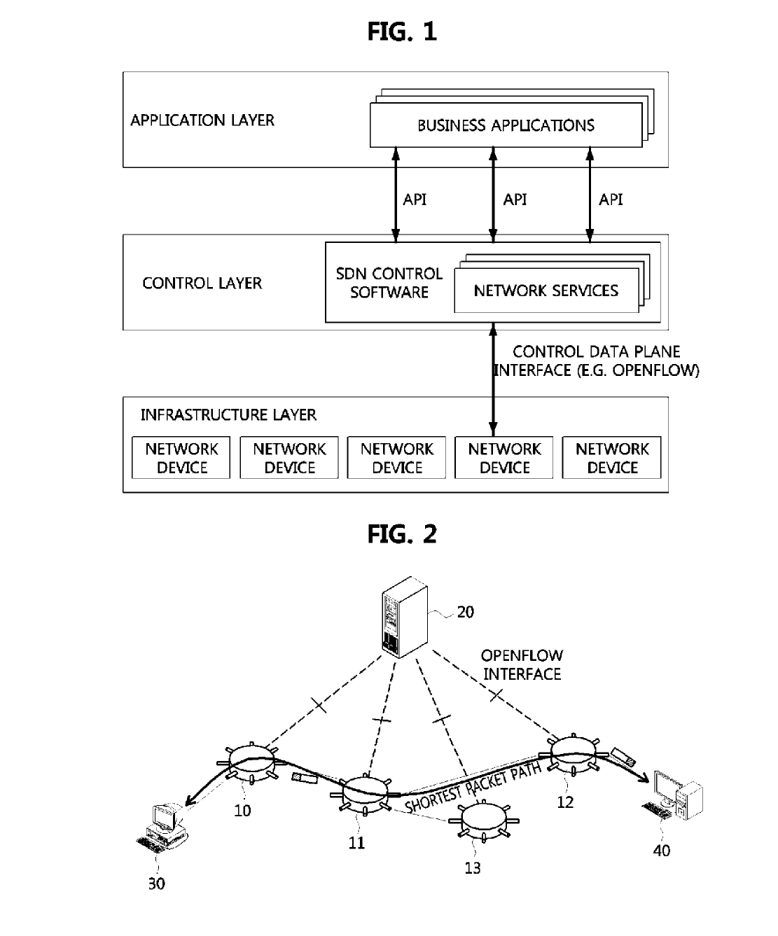

FIG. 1 is a conceptual diagram illustrating an example structure of software defined networking (SDN).

Referring to FIG. 1, a logical structure of the SDN may include an infrastructure layer, and a control layer and an application layer. The infrastructure layer includes a plurality of network devices and is connected to the control layer via a control data plane interface (for example, OpenFlow). The control layer includes the SDN control software, which supports a plurality of network services. The SDN control software is connected to the application layer via application programming interface (API). The application layer includes a plurality of business applications.

FIG. 2 is a conceptual diagram illustrating an example embodiment for controlling packet path in network supporting SDN.

Referring to FIG. 2, a network controller 20 may control path of packets which are transmitted through network apparatuses (for example, switch etc.) 10, 11, 12, and 13. When packets are exchanged between a first terminal 30 and a second terminal 40, the network controller 20 may provide flow information which is information about forwarding path of packets to each of network apparatuses 10, 11, 12, and 13 via OpenFlow interface. Each of network apparatuses 10, 11, 12, and 13 may forward the packets to next network apparatus or terminal based on the flow information.

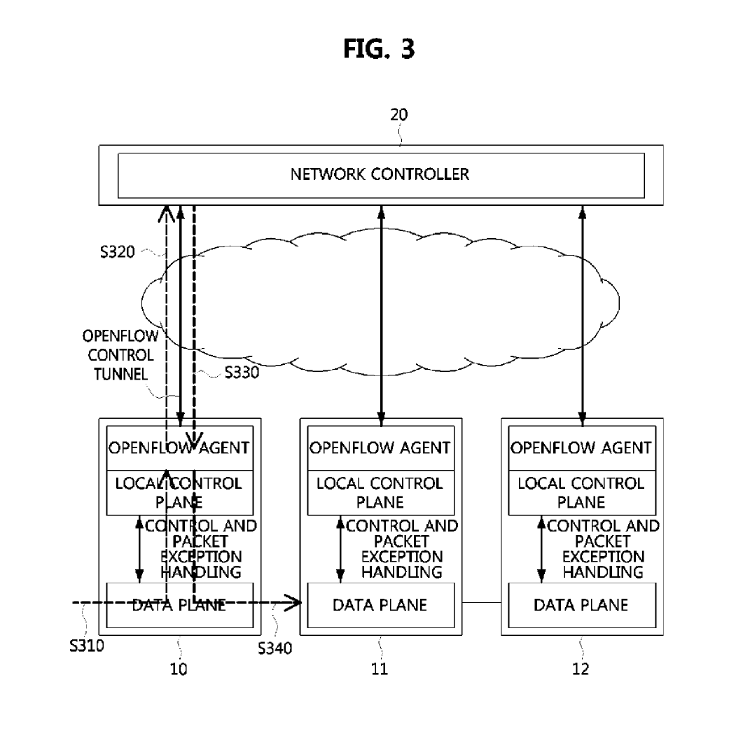

FIG. 3 is a conceptual diagram illustrating an example embodiment of a packet forwarding method.

Referring to FIG. 3, there are a plurality of network apparatuses 10, 11, and 12 which forward packets and a network controller 20 which control the plurality of network apparatuses 10, 11, and 12 in network. Each of network apparatuses may be a switch supporting SDN technologies and include a data plane, a local control plane, and an OpenFlow agent as logical components. The network controller 20 may be a controller supporting SDN technologies.

A first network apparatus 10 may receive packet from other network apparatus or an user terminal. At this time, the first network apparatus 10 may receive the packet via the data plane. The first network apparatus 10 may check whether flow information needed for forwarding the received packet is available in flow table of it. When the flow information is available in the flow table, the first network apparatus 10 may forward the received packet to other network apparatus (for example, a second network apparatus 11) or an user terminal based on the flow information.

On the contrary, when the flow information need for forwarding the received packet is not available in the flow table, the first network apparatus 10 may perform exception handling on the received packet via the local control plane (S310). Then, the first network apparatus 10 may transmit some of the received packet or all of the received packet to the network controller as format of a message via OpenFlow control tunnel (S320). The OpenFlow control tunnel may be a Secure Sockets Layer (SSL) tunnel formed between the first network apparatus 10 and the network controller 20.

The network controller 20 may determine a method of packet forwarding and generate the flow information based on the determined method after the packet has been received from the first network apparatus 10. The network controller 20 may provide the packet received from the first network apparatus 10 and the generated flow information to the first network apparatus 10 as format of a message (S330). The first network apparatus 10 may receive the flow information and the packet through the local control plane from the network controller 20. Then, the first network apparatus 10 may forward the packet to other network apparatus (for example, the second network apparatus 11 or the third network apparatus 12) based on the flow information (S340).

According to above-mentioned the procedure, an efficiency of packet forwarding decreases because this procedure is performed iteratively in each of network apparatuses 10, 11, and 12.

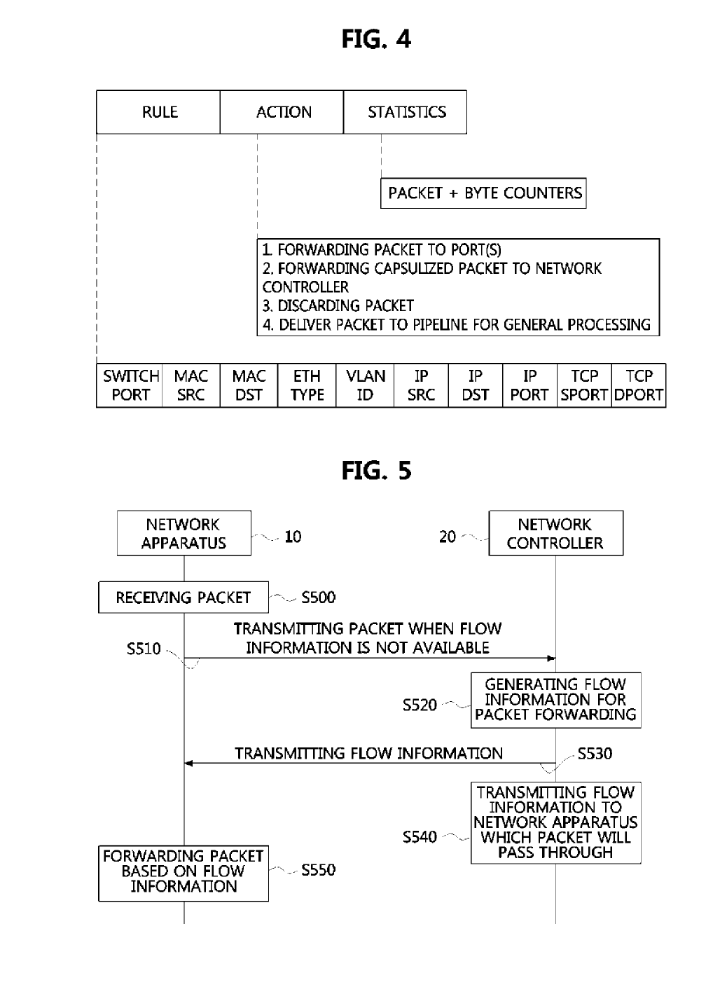

FIG. 4 is a conceptual diagram illustrating a flow table.

Referring to FIG. 4, the flow table may include at least one of flow information, and the flow information may include at least one of information on flow rule, information on action, and information on statistics.

Here, the information on flow rule may represent packet header information defining flow, and the information on action may represent how to handle packet, and the information on statistics may represent statistical information on each flow.

FIG. 5 is a flow chart illustrating an example embodiment of packet forwarding method according to the present invention.

Referring to FIG. 5, the network apparatus 10 may perform a function of packet forwarding, and the network controller 20 may control the network apparatus 10. The network apparatus 10 may be a switch supporting the SDN technology and include a data plane and a control plane as logical components. The network controller 20 may be a controller supporting the SDN technology. The flow table and the flow information may be the components illustrated in FIG. 4, and the flow table is stored in the network apparatus 10.

The network apparatus 10 may receive packet from an user terminal or other network apparatus (S500). The network apparatus 10 may determine whether flow information needed for forwarding the received packet is in the flow table. When the flow information needed for forwarding the received packet is in the flow table, the network apparatus 10 may forward the packet to the other network apparatus based on the flow information.

On the contrary, when the flow information needed for packet forwarding is not in the flow table, the network apparatus 10 may provide the received packet to the network controller 20 via the data plane (S510). At this time, the network apparatus 10 may provide the received packet to the network controller 20 based on OpenFlow protocol. That is, the network apparatus 10 may provide the received packet to the network controller 20 via a secure tunnel formed between the data plane of it and the network controller 20.

The network controller 20 may generate the flow information needed for forwarding the received packet after the packet has been received from the network apparatus 10 (S520). That is, the network controller 20 may determine a method of packet forwarding and generate the flow information based on the determined method.

The network controller 20 may transmit a message including the flow information to the network apparatus 10 (S530). Here, the message may include only the flow information and may not include the packet received from the network apparatus 10.

Meanwhile, the network controller 20 may transmit the message including the flow information to other network apparatus (that is, network apparatuses which the packet from the network apparatus 10 will pass through) as well as the network apparatus 10 (S540). Also, the network controller 20 may transmit the packet received from the network apparatus 10 to other network apparatus (that is, network apparatuses which the packet will pass through in order to arrive at the final destination).

The network apparatus 10 may receive the message including the flow information via the control plane from the network controller 20 (S530). At this time, the network apparatus 10 may receive the message including the flow information based on OpenFlow protocol. That is, the network apparatus 10 may receive the message including the flow information through a secure tunnel formed between the control plane of it and the network controller 20 from the network controller 20. The network apparatus 10 may forward the packet to other network apparatus or an user terminal based on the received flow information (S550).

The method of packet forwarding according to an embodiment of the present invention may be implemented as program instructions executable by a variety of computers, and then recorded on a computer readable medium. The computer readable medium may include a program instruction, a data file, a data structure, or a combination thereof. The program instructions recorded on the computer readable medium may be designed and configured specifically for the present invention or can be publically known and available to those who are skilled in the field of software.

Examples of the computer readable medium may include a hardware device such as a ROM, a RAM, or a flash memory, which is specifically configured to store and execute the program instructions. Examples of the program instructions can include machine codes made by, for example, a compiler, as well as high-level language codes executable by a computer with an interpreter. The above exemplary hardware devices can be configured to operate as one or more software modules in order to perform the operation in an exemplary embodiment, and the opposite is also possible.

FIG. 6 is a conceptual diagram illustrating an example embodiment of packet forwarding method according to the present invention.

Referring to FIG. 6, there are a plurality of network apparatuses 10, 11, and 12 which forward packets and a network controller 20 which control the plurality of network apparatuses 10, 11, and 12 in network. Each of network apparatuses may be a switch supporting SDN technologies and include a data plane, a local control plane, and an OpenFlow agent as logical components. The network controller 20 may be a controller supporting SDN technologies.

A first network apparatus 10 may receive packet from other network apparatus or an user terminal At this time, the first network apparatus 10 may receive the packet via the data plane. The first network apparatus 10 may check whether flow information needed for forwarding the received packet is available in flow table of it. When the flow information is available in the flow table, the first network apparatus 10 may forward the received packet to other network apparatus or an user terminal based on the flow information.

On the contrary, when the flow information is not available in the flow table, the first network apparatus 10 may transmit the packet to the network controller 20 via a tunnel dedicated for data (S610). The tunnel dedicated for data may be a secure tunnel formed between the first network apparatus 10 (that is, the data plane of the first network apparatus 10) and the network controller 20.

The network controller 20 may determine a method of packet forwarding and generate the flow information based on the determined method after the packet has been received from the first network apparatus 10. The network controller 20 may transmit the message including the generated flow information to the first network apparatus 10 via OpenFlow control channel (S620). The OpenFlow control channel may be a secure tunnel formed between the first network apparatus 10 (that is, the local control plane of the first network apparatus 10) and the network controller 20.

The first network apparatus 10 may receive the message including the flow information from the network controller 20 via the local control plane. Then, the first network apparatus 10 may forward the packet to other network apparatus (for example, the second network apparatus 11 or the third network apparatus 12) based on the flow information.

Meanwhile, the network controller 20 may transmit the message including the flow information to other network apparatus (that is, network apparatus which the packet transmitted from the first network apparatus 10 will pass through) (S630). That is, the network controller 20 may transmit the message including the flow information to the next network apparatus (for example, the second network apparatus 11) which the packet will pass through or all network apparatuses (for example, the second network apparatuses 11 and the third network apparatus 12) which the packet will pass through.

The network controller 20 may transmit the packet received from the first network apparatus 10 to the next network apparatus which the packet will pass through (S640). For example, when the packet is transmitted from the first network apparatus 10 to the second network apparatus 20, the network controller 20 may transmit the packet received from the first network apparatus 10 to the second network apparatus 11.

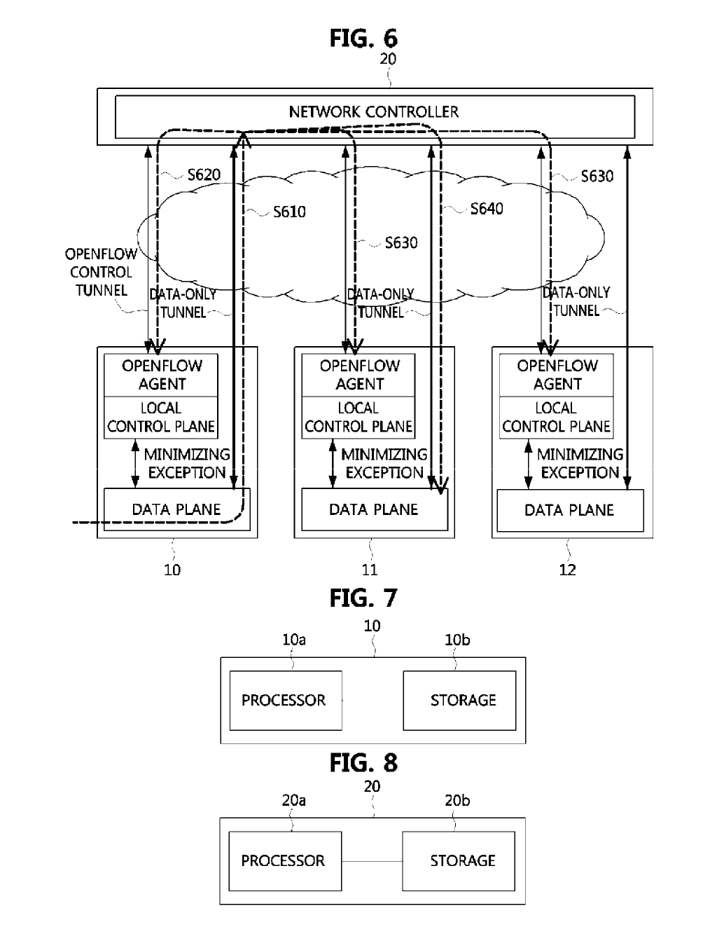

FIG. 7 is a block diagram illustrating an example embodiment of a network apparatus according to the present invention.

Referring to FIG. 7, the example embodiment of the network apparatus 10 may include a processor 10a and storage 10a as physical components. The network apparatus 10 may be a switch supporting SDN technologies. Meanwhile, the network apparatus 10 may include a data plane and a control plane as logical components.

The processor 10a may be configured to receive a packet from other network apparatus or an user terminal and determine whether flow information needed for forwarding the received packet is available or not. When the flow information is available in a flow table of it, the processor 10a may forward the received packet to other network apparatus based on the flow information.

Meanwhile, when the flow information is not available in the flow table of it, the processor 10a may transmit the received packet to a network controller via the data plane. Here, the network controller may be a controller which controls a plurality of network apparatuses.

The processor 10a may receive a message including the flow information on the received packet from the network controller. At this time, the processor 10a may receive the message including the flow information via the control plane. The processor 10a may forward the received packet to other network apparatus based on the flow information received from the network controller.

Here, the processor 10a may include a processing unit and a memory. The processing unit may be a general purpose CPU (Central Processing Unit) such as ARM or x86 CPU, a GPU (Graphics Processing Unit) or a dedicated processing unit designed for performing packet forwarding by using FPGA etc. The memory may store a program code to perform the packet forwarding. That is, the processing unit may read the program code from the memory and execute the program code to perform the packet forwarding.

The storage 10a may store the information to be processed 10a by the processor 10a and the information processed by the processor 10a. For example, the storage 10a may store the packets, the flow information, and the flow table in it etc.

FIG. 8 is a block diagram illustrating an example embodiment of a network controller according to the present invention.

Referring to FIG. 8, the example embodiment of the network controller 20 may include a processor 20a and storage 20a as physical components, and may control a plurality of network apparatuses. The network controller 20 may be a controller supporting the SDN technologies.

The processor 20a may receive a packet from a network apparatus. At this time, the processor 20a may receive the packet via a secure tunnel formed between the data plane of the network apparatus and the network controller 20. The processor 20a may generate flow information needed for forwarding the received packet. That is, the processor 20a may determine a proper packet forwarding method and generate the flow information according to the determined method.

The processor 20a may transmit a message including the flow information to the network apparatus (that is, the network apparatus which transmitted the packet to the network controller 20). At this time, the processor 20a may transmit the message via a secure tunnel formed between the control plane of the network apparatus and the network controller 20.

Meanwhile, the processor 20a may transmit the message including the flow information to other network apparatus (that is, the next network apparatus or all the network apparatus which the packet will pass through). Also, the processor 20a may transmit the packet received from the network apparatus to other network apparatus (that is, network apparatuses which the packet will pass through).

Here, the processor 20a may include a processing unit and a memory. The processing unit may be a general purpose CPU (Central Processing Unit) such as ARM or x86 CPU, a GPU (Graphics Processing Unit) or a dedicated processing unit designed for performing a method of supporting packet forwarding according to the present invention by using FPGA etc. The memory may store a program code to perform the method. That is, the processing unit may read the program code from the memory and execute the program code to perform the method of supporting the packet forwarding.

The storage 20a may store the information to be processed by the processor 20a and the information processed by the processor 20a. For example, the storage 20a may store the packets, the flow information, and the flow table in it etc.

According to the present invention, an efficiency of packet forwarding can be increased by simplifying a configuration procedure on a flow rule for newly input packet in network supporting SDN technologies. That is, a data plane of a network apparatus may directly transmit newly received packet to a network controller to acquire the flow rule for the newly input packet. Thus, the packet exchange step between the data plane and a control plane of the network apparatus may be omitted.

Meanwhile, since the network controller may transmit a message including the flow rule only for the newly input packets, the efficiency of packet forwarding can be further increased as compared to the conventional method transmitting a message including flow rules and packets.

Also, since the network controller may transmit the flow rule for the newly input packet to other network apparatus which the packet will pass through, the efficiency of packet forwarding can be further increased.

While the example embodiments of the present invention and their advantages have been described in detail, it should be understood that various changes, substitutions and alterations may be made herein without departing from the scope of the invention.

What is claimed is:

1. A method of packet forwarding performed in a network apparatus, the method comprising:
receiving at least one packet;
providing the at least one packet to a network controller through a data plane when flow information to forward the at least one packet is not available; and
receiving a message including the flow information to forward the at least one packet from the network controller through a control plane.

2. The method of claim 1, further includes forwarding the at least one packet based on the flow information.

3. The method of claim 1, further includes forwarding the at least one packet based on the flow information when the flow information is available.

4. The method of claim 1, wherein the at least one packet is provided to the network controller based on OpenFlow protocol.

5. The method of claim 1, wherein the message including the flow information is a message based on OpenFlow protocol.

6. The method of claim 1, wherein the network apparatus is a switch supporting software defined networking (SDN) technology.

7. The method of claim 1, wherein the network controller is a controller supporting software defined networking (SDN) technology.

8. The method of claim 1, wherein the flow information includes at least one of information on a flow rule, information on an action, and information on a statistics.

9. A method of supporting packet forwarding performed in a network controller controlling a network apparatus, the method comprising:
receiving at least one packet from the network apparatus;
generating flow information to forward the at least one packet; and
transmitting the flow information to the network apparatus.

10. The method of claim 9, further includes transmitting the flow information to a network apparatus which the at least one packet will pass through.

11. The method of claim 9, wherein the at least one packet is received from the network apparatus based on OpenFlow protocol.

12. The method of claim 9, wherein the flow information is generated including at least one of information on a flow rule, information on an action and information on a statistics.

13. The method of claim 9, wherein the flow information is transmitted to the network apparatus based on OpenFlow protocol.

14. The method of claim 9, wherein the network apparatus is a switch supporting software defined networking (SDN) technology.

15. The method of claim 9, wherein the network controller is a controller supporting software defined networking (SDN) technology.

16. An apparatus for packet forwarding, the apparatus comprising:
a processor configured to receive at least one packet, provide the at least one packet to a network controller through a data plane when flow information for forwarding the at least one packet is not available, and receive a message including the flow information from the network controller through a control plane; and
a storage configured to store information to be processed by the processor and information processed by the processor.

17. The apparatus of claim 16, wherein the processor is configured to forward the at least one packet based on the flow information received from the network controller.

18. The apparatus of claim 16, wherein the processor is configured to form a network with the network controller based on OpenFlow protocol.

19. The apparatus of claim 16, wherein the network apparatus is a switch supporting software defined networking (SDN) technology.

20. The apparatus of claim 16, wherein the flow information includes at least one of information on a flow rule, information on an action, and information on a statistics.
